(19) United States
(12) Patent Application Publication
(10) Pub. No.: US 2025/0208285 A1
(43) Pub. Date: Jun. 26, 2025

(54) METHODS AND SYSTEMS FOR DETERMINING A TUMBLING STATE OF A MOVING OBJECT

(71) Applicant: Lockheed Martin Corporation, Bethesda, MD (US)

(72) Inventors: Tod M. Schuck, Lumberton, NJ (US); Mark A. Friesel, Ewing, NJ (US)

(21) Appl. No.: 17/383,249

(22) Filed: Jul. 22, 2021

(51) Int. Cl. G01S 13/72; G01S 13/58

(52) U.S. Cl. CPC G01S 13/72; G01S 13/583

(57) ABSTRACT

A system for classifying an unclassified object includes an electronic processor. The electronic processor is configured to receive, from a radar system, measurement data associated with the unclassified object, determine a set of characteristics of the unclassified object based on the measurement data, determine an object classification for the unclassified object based on the set of characteristics, and control a tracking system based on the object classification of the unclassified object.

### FIELD OF INVENTION

This disclosure relates to detecting and classifying targets using radar, and more particularly, to determining a tumbling state of a moving object.

### BACKGROUND OF THE INVENTION

Aerial objects, such as long-range ballistic missile (“BM”) threats, frequently employ multiple stages to achieve exo-atmospheric altitudes. These threats may produce multiple radar-detectable components prior to and during re-entry into the atmosphere. These components may include a re-entry vehicle (“RV”), one or more booster stages, various types of debris or chaff, or a combination thereof among other airborne or falling objects associated with the missile. Generally, an RV is designed in such a way as to achieve re-entry in a controlled manner in order to accurately strike an intended target area. Other components typically exhibit uncontrolled movements, as these components are not intended to re-enter the atmosphere and reach a specific point. These components may burn up during re-entry, may fall randomly, or a combination thereof. Such objects present challenges to threat countermeasures (for example, an interceptor missile) as it may not be possible to differentiate these objects from a threat target, such as an RV, within and/or at the time an engagement order is to be issued. Alternative systems and methods for detection, differentiation, and classification of these airborne objects are desired.

### SUMMARY

To solve these and other problems, the embodiments described herein provide, among other things, methods and systems for determining a tumbling state of a moving object. For example, one embodiment provides a method for classifying an airborne object detected by a radar system. The method includes identifying and classifying complex motion generated from received radar return signals. A tumbling object exhibits a variety of rotational, Doppler-shifted returns to a radar system that may be calculated from spectral, cepstral, and autocorrelation processing. These complex, rotational returns represent certain physical feature dimensions that may be extracted. The method further includes calculating the physical features of the airborne object. A physical feature of the airborne object may include, for example, a shape of the airborne object (for example, a cone, a cylinder, and the like), a dimensional ratio of the airborne object, a dimension of the airborne object (for example, a length, a width, and the like), and the like. The physical features may be compared to known or predetermined physical features stored in a classification database, where an object classification decision is made upon identifying a match between calculated physical features and known physical features of an object stored in the database.

For example, one embodiment provides a system for classifying an unclassified object. The system includes an electronic processor configured to receive, from a radar system, measurement data associated with the unclassified object. The electronic processor is also configured to determine a set of characteristics of the unclassified object based on the measurement data. The electronic processor is also configured to determine an object classification for the unclassified object based on the set of characteristics. The electronic processor is also configured to control a tracking system based on the object classification of the unclassified object.

Another embodiment provides a method for classifying an unclassified object. The method includes receiving, from a radar system, measurement data associated with the unclassified object. The method also includes determining, with an electronic processor, a set of characteristics of the unclassified object based on the measurement data. The method also includes determining, with the electronic processor, an object classification for the unclassified object based on the set of characteristics. The method also includes controlling a tracking system based on the object classification of the unclassified object.

Yet another embodiment provides a non-transitory, computer-readable medium storing instructions that, when executed by an electronic processor, perform a set of functions. The set of functions includes receiving, from a radar system, measurement data associated with the unclassified object. The set of functions also includes determining a set of characteristics of the unclassified object based on the measurement data. The set of functions also includes determining an object classification for the unclassified object based on the set of characteristics. The set of functions also includes controlling a tracking system based on the object classification of the unclassified object.

Other aspects and embodiments will become apparent by consideration of the detailed description and accompanying drawings.

### BRIEF DESCRIPTION OF THE DRAWINGS

FIG. 1 schematically illustrates a system for determining a tumbling state of a moving object according to some embodiments.

FIGS. 2A-2B and 3 schematically illustrate a radar system included in the system of FIG. 1, according to some embodiments.

FIG. 4 schematically illustrates a server included in the system of FIG. 1, according to some embodiments.

FIG. 5 is a flowchart illustrating a method for determining a tumbling state of a moving object performed by the system of FIG. 1, according to some embodiments.

FIGS. 6A-6B schematically illustrate a tumbling object according to some embodiments.

### DETAILED DESCRIPTION

Before any embodiments are explained in detail, it is to be understood the embodiments are not limited in their application to the details of construction and the arrangement of components set forth in the following description or illustrated in the following drawings. Other embodiments are possible and embodiments described and/or illustrated here are capable of being practiced or of being carried out in various ways.

It should also be noted that a plurality of hardware and software-based devices, as well as a plurality of different structural components may be used to implement the embodiments described herein. In addition, embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the embodiments may be implemented in software (for example, stored on non-transitory computer-readable medium) executable by one or more processors. As such, it should be noted that a plurality of hardware and software-based devices, as well as a plurality of different structural components may be utilized to implement various embodiments. It should also be understood that although certain drawings illustrate hardware and software located within particular devices, these depictions are for illustrative purposes only. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

As the sophistication of ballistic and terrestrial threats advances, the need for improved methods of threat discrimination and fire control references also increases. Present discrimination methods are limited to the use of conventional and familiar metrics, such as physics-based features of moments, centripetal accelerations, relative size, specific energy, angular momentum, and the like. Approaches which attempt to leverage these familiar metrics often over-task sensors with respect to their core functionality (for example, volume search radars). For example, current radar processing discrimination systems and methods require a mode change and generation of large numbers of duty cycles for quasi imaging, as well as requiring significantly large bandwidths (for example, on the order of hundreds of MHz) when utilizing the above described metrics to attempt object classification. Embodiments of the present disclosure overcome these technological obstacles inherent in such systems by means of a high resolution Doppler radar system with a resolution of about ten hertz (10 Hz) or with a high pulse repetition frequency (“PRF”) of at least 20,000 Hz with integrated phenomenology based discrimination processing disclosed herein, to thereby improve one or more of system detection, determination, classification, and control of moving objects that may exhibit ballistic and/or non-ballistic motion or behavior. Furthermore, existing sensor technologies are strained by increased tactical and operational capabilities of modern threats, such as increased range of operations, increased maneuverability, deployment of counter-measures, and the like.

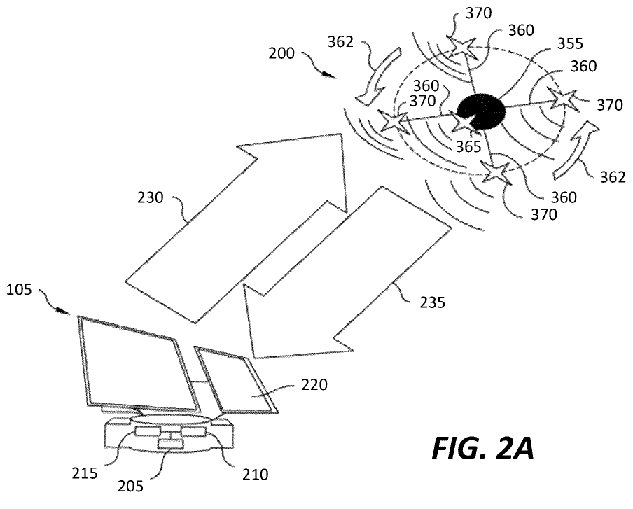

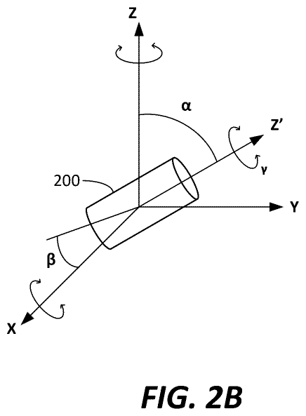

Embodiments described herein include X-band, C-band, or at least S-band high resolution Doppler radar processors integrated with phenomenology-based discrimination processing for measuring select cyclic Doppler characteristics of one or more airborne objects or targets of interest. The system transforms in frequency and quefrency space measured characteristics utilizing select characteristics or metrics to detect and determine object micro-motion (for example, rotations (FIG. 2A) and/or tumbling (FIG. 2B)) with enhanced accuracy, and with reduced processing requirements and significantly narrower bandwidth. Embodiments may provide high quality object identification, classification, and other benefits, based on narrow bandwidth in the range of 100 kHz to 300 kHz at X-band. Still further, embodiments of the present Doppler radar and integrated phenomenology-based discrimination system and method provide for less computer processing intensive operations, in contrast to the high processing loads required for processing large bandwidth signals needed for present computerized determination and classification systems.

In some embodiments, a high resolution Doppler radar system and method with integrated phenomenology based discrimination processing may comprise a continuous wave (“CW”) radar or frequency modulated CW radar or other high resolution Doppler radar with high PRF or a frequency modulated waveform configured to process observed phenomena based on the physics of motion, material property exploitation, and environmental interaction for one or more of the purposes of detection, identification, classification, fire control reference generation, and the like. Furthermore, cyclic processing of measured return data is employed to identify and analyze motion-related phenomenology to exploit target characteristics that exhibit select behaviors, such as non-ballistic gross motions, and micro-motions, by way of non-limiting example.

Accordingly, embodiments described herein advantageously utilize the tendency of objects exhibiting ballistic or non-ballistic behaviors to provide “tells” or identifiable characteristics as to an object's classification or function. Reflections of transmitted radar signals directed at both ballistic and non-ballistic objects may be processed by a radar processor according to a cyclic processing method that enables the threat targets within a radar scene to be identified and isolated with greater confidence. According to one or more embodiments, a radar system employing cyclic processing methods enables effective threat classification. Embodiments provide increased effectiveness for identifying and classifying threats and provide the benefits of a reduction in the number of countermeasures (for example, missiles) needed per engagement event, an increase in the probability of engagement support (Pes), improved target object mapping (“TOM”) information, and increased performance against varying threat sets, by way of example.

A potential target or threat, in particular, a threat object exhibiting non-ballistic motion (for example, a controlled flight), will frequently possess one or more rotational structures associated with the object. For example, the threat object may have propeller blades for thrust, rocket fins for stabilization or steering, outlets (for example, exhaust ports), bolts, rivets, or the like which are disposed on a surface of a main body of the object. Frequently, these structures will rotate relative to the main body of the object. The rotational movement of these structures may define periodic motion relative to the overall motion of the object, and impart a periodic modulation of the scattered and reflected radar energy off the object, given the radar signal wavelength is sufficiently short relative or incident to the dimensions of the object(s) being reflected. Further, the rotational structures associated with the target object may provide unique identifiers that may be discerned by processing the amplitude and phase components of a reflected radar waveform (for example, planar wave).

An exemplary reflected radar waveform varies with time. However, when the individual elemental scatterers responsible for the reflections are rotated in a continuous, periodic manner, then both the phase and amplitude of the reflected waveform vary in a continuous, periodic manner. This allows embodiments to utilize cyclostationary techniques where, in the case of rotating objects, the signal statistics are stationary and time invariant over the periodic interval equal to one rotational period of the object's main body across all three spatial dimensions. In this phenomenology, the statistics of the rotating structures are also ergodic, and the system allows event samples to replace time samples in the analysis. This is significant in that absolute time is replaced by events that occur over the relative rotational period Tₚ. Accordingly, the scatterers are cyclic across this interval, or epoch, and may be characterized by periodic changes in phase ø (t) and amplitude a (t) over period Tₚ. For an object in cyclic motion that represents a tumble, there are up to three rotations that are defined by three different periods (Tₚ₁, Tₚ₂, Tₚ₃) that correspond with the three Euler angles that represent spin (φ), precession (γ), and nutation (θ) of an object with complex motion.

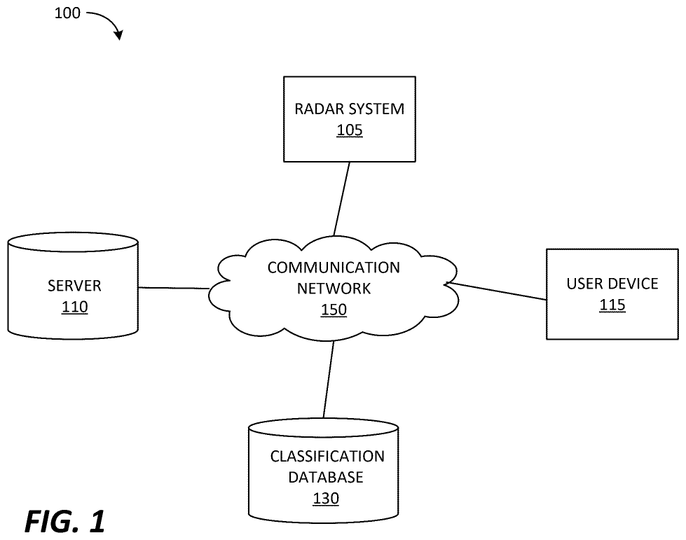

FIG. 1 illustrates a system 100 for determining a tumbling state of a moving object according to some embodiments. In the illustrated example, the system 100 includes a radar system 105, a server 110, a user device 115, and a classification database 130. In some embodiments, the system 100 includes fewer, additional, or different components than illustrated in FIG. 1. For example, the system 100 may include multiple radar systems 105, servers 110, user devices 115, classification databases 130, or a combination thereof.

The radar system 105, the server 110, the user device 115, and the classification database 130 communicate over one or more wired or wireless communication networks 150. Portions of the communication networks 150 may be implemented using a wide area network, such as the Internet, a local area network, such as a Bluetooth™ network or Wi-Fi, and combinations or derivatives thereof. Alternatively or in addition, in some embodiments, components of the system 100 communicate directly as compared to through the communication network 150. Also, in some embodiments, the components of the system 100 communicate through one or more intermediary devices not illustrated in FIG. 1.

FIG. 2A illustrates a high Doppler resolution radar system (for example, the radar system 105), such as an X-band, C-band, or at least S-band CW (or frequency modulated CW) radar system, useful in implementing the systems and methods according to some embodiments. CW radar is a type of radar in which a known frequency continuous wave (for example, not pulsed) is transmitted by a radar transmitter into the air or atmosphere. The continuous wave signal impinges on one or more objects in the signal's path and the signal is reflected to a radar receiver. CW radar is based on the Doppler principle, in which the frequency of the reflected signal varies as a function of the relative motion and velocity of the object reflecting the signal. Doppler radar is largely immune to interference caused by large, stationary objects and slow-moving clutter within the radar's field of view.

The radar system 105 detects an airborne target or threat 200 (for example, an object 200). As seen in FIG. 2A, the radar system 105 includes a radar electronic processor 205, a radar memory 210, an antenna controller 215 (for example, a transmit/receive controller), and an antenna array of radar sensors or radiating antenna elements 220 (referred to herein as “antenna elements 220”). The radar electronic processor 205, the radar memory 210, the antenna controller 215, and the antenna elements 220 communicate wirelessly, over one or more communication lines or buses, or a combination thereof. In some embodiments, the radar system 105 includes fewer, additional, or different components than illustrated in FIG. 2A.

The radar electronic processor 205 includes a microprocessor, an application-specific integrated circuit (ASIC), or another suitable electronic device for processing data, and the radar memory 210 includes a non-transitory, computer-readable storage medium. The radar electronic processor 205 is configured to retrieve instructions and data from the radar memory 215 and execute the instructions. In some embodiments, the radar system 105 also includes the antenna controller 215, which is in communication with the radar memory 210 and radar electronic processor 205. The antenna controller 215 may include a second (or additional) electronic processor, memory, communication interface, and the like which may be configured to control signals transmitted (for example, from a transmitter) and received (for example, with a receiver) by radar system 105 via the antenna elements 220.

As seen in FIG. 2A, the radar system 105 transmits and directs radar signals 230 toward the object 200. The transmitted radar signals 230 impinge on the object 200 and are reflected back to the radar system 105 as radar return signals 235. The radar return signals 235 are received by the antenna elements 220 and processed via, for example, the radar electronic processor 205, the antenna controller 215, or a combination thereof. In some embodiments, the processed radar return signals 235 are transmitted to another device (for example, the server 110) for remote or virtual processing. As one example, the radar system 105 (via, for example, the radar electronic processor 205) may transmit the radar return signals 235 as raw measurement data or readings to the server 110 for identifying and classifying the object 200.

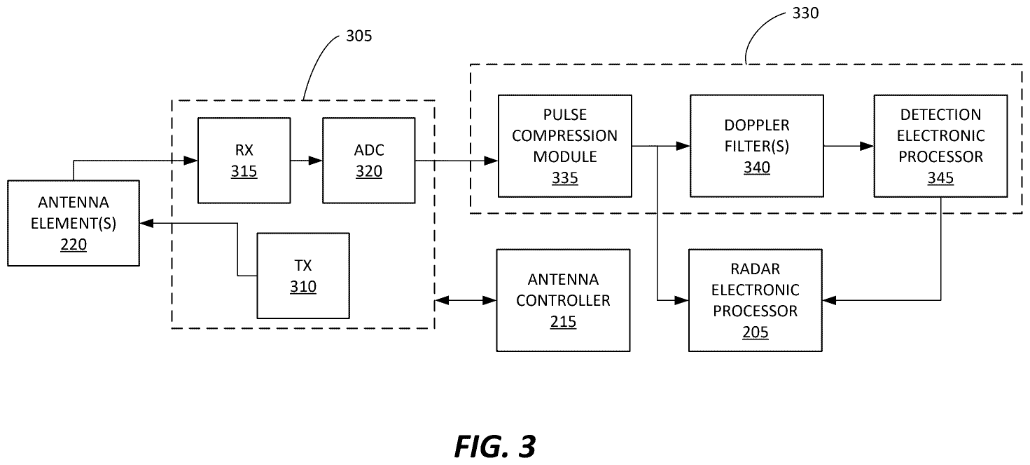

FIG. 3 illustrates a more detailed view of the radar system 105 of FIG. 2A according to some embodiments. As seen in FIG. 3, the radar system 105 may include a front-end module 305. The front-end module 305 may include a transmitter 310, a receiver 315, and one or more analog to digital converters (“ADC”) 320. The transmitter 310 is responsive to the antenna controller 215 for generating and transmitting one or more waveforms from the antenna elements 220. Reflected return signals (for example, the radar return signals 235) resulting from the transmitted signals (for example, the transmitted radar signals 230) are subsequently received or captured by the antenna elements 220 and provided to the receiver 315 for signal modulation. The receiver 315 may include multiple processing components, such as one or more filters, low-noise amplifiers, down converters, and the like. The ADC 320 converts received analog return signals to digital form.

In some embodiments, the radar system 105 may also include a digital processing system 330, as seen in FIG. 3. The digital processing system 330 may include a pulse compressor or pulse compression module 335, one or more doppler filters 340, and a detection electronic processor 345 (for example, a microprocessor, an application-specific integrated circuit (“ASIC”), or another suitable electronic device for processing data). The pulse compression module 335 is operative to receive post-A/D digitized in-phase and quadrature-phase (I/Q) signal data from the front-end module 305. Pulse compression techniques may be implemented to achieve high range resolution without the need for high-powered antennas. Pulse compression may be accomplished by various filtering and/or line delay arrangements. As one example, pulse compression may be achieved by applying a Fast Fourier Transform (“FFT”) to a received time-domain signal, thereby converting the data to the frequency domain. A weighting factor or pulse compression weight (for example, in the form of a vector-matrix) is applied in the frequency domain. An inverse FFT (“IFFT”) is applied to return the data streams to the time-domain.

The output of the pulse compression module 335 includes modulated data that may be subject to further processing, such as sampling the incoming data into range cells or bins, and generating one sample in each range bin for each pulse. Range bin data is provided to the Doppler filters 340, which generate a series of Doppler bins for each range cell. Data from a particular Doppler bin corresponds to a signal from a target or background, at a given range, moving at a particular velocity. Once Doppler-filtered, return data is provided to the detection electronic processor 345 operative to, for example, perform a target detection process against a time-averaged background map. These detection processes may include one or more of “greatest of” operations, as well as CFAR detection techniques. The results of this detection processing may be provided to, for example, a display device for end-user interfacing. The detection electronic processor 345 may be further configured to perform constant false alarm rate processing by comparing the powers of each range/Doppler cell to a background clutter map.

Returning to FIG. 2A, the object 200 may be an aerial object, such as a ballistic missile. Ballistic missile technologies have developed where upon re-entry into the Earth's atmosphere, the RV may possess aerodynamic features or structures that allow for controlled flight. As one example, projections or appendages, such as wings, rudders or flaps, may be present for facilitating controlled flight operations to guide the object 200 toward an intended target. As seen in FIG. 2A, object 200 may include a main body 355 and one or more fins 360 generally extending radially, for example, from the main body 355. During controlled flight, the object 200 may rotate as indicated by directional arrows 362 about a longitudinal axis of main body 355. Alternatively or in addition, the object 200 may be a tumbling object, such that the object 200 is a freely rotating object in a state of spin, nutation, precession, or a combination thereof, as illustrated in FIG. 2B.

As the main body 355 rotates, transmitted radar signals 230 impinge on the main body 355 at an example location or position 365. Similarly, as the fins 360 rotate about the main body 355, extended portions of the fins 355 (for example, illustrated in FIG. 2A as one or more fin tips 370) revolve around the main body 355. As the fin tips 370 revolve around the main body 355, the velocity of the fin tips 370 (in relation to the radar system 105) changes cyclically or periodically. As any one of the fin tips 370 revolves, the fin tip 370 moves away from the radar system 105 for one half of the revolution cycle, while moving toward the radar system 105 during the other half of the revolution. This change in relative velocity causes variations in the frequency of reflected radar signals 235 as compared to transmitted radar signals 230 due to the Doppler effect. As the fin tip 370 approaches the radar system 105, the transmitted radar signals 230 are transmitted at a first frequency determined by the antenna controller 215. The transmitted radar signals 230 impinge on the revolving fin tip 370 as the revolving fin tip 370 moves toward the source of the transmitted radar signals 230. This relative motion causes the reflected radar signal 235 from the fin tip 370 to be at a higher frequency than the transmitted radar signal 230. Likewise, when the fin tip 370 is moving away from the radar system 105 (for example, in the same direction as the transmitted radar signal 230), the reflected radar signal 235 is received at a lower frequency than the transmitted frequency of the transmitted radar signals 230. As a result of the rotation of the object 200, these movements of the fin tips 370 are periodic, and the frequency of the reflected radar signal 235 increases and decreases as the object 200 rotates corresponding to motion of the fin tips 370 toward and away from the radar system 105.

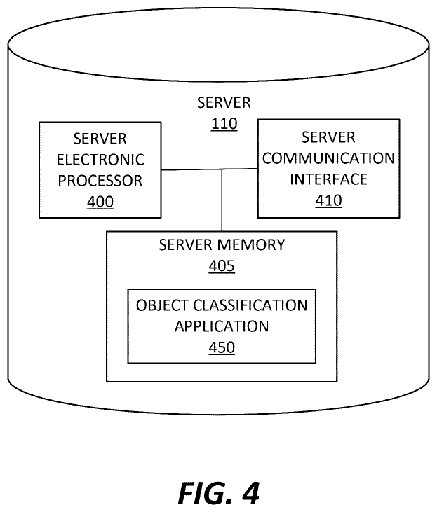

Similarly, as illustrated in FIG. 2B, the aerial object may be exhibiting a tumbling motion about its midpoint in a state of spin, nutation, precession, or a combination thereof. In the same way that object 200 spins or rotates in FIG. 2A, it can also tumble per FIG. 2B and exhibit similar radar reflective processes as shown in FIG. 2A. However, in this case all three Euler angles that represent spin (φ), precession (γ), and nutation (θ) of an object with complex motion are exhibited. The same cyclic periodicity (Tₚ) as shown in FIG. 2A is present in FIG. 2B, however this is primarily due to the complex motion of the tumbling object across the three cyclic Euler periods (Tₚ₁, Tₚ₂, Tₚ₃), not necessarily due to the relative motion of fins and other structures which may or may not be present. The same physics phenomenology illustrated in FIG. 2A is applicable to FIG. 2B. However, the domain for processing in system 330 is increased from one dimension to three simultaneous dimensions representing spin, precession, and nutation. Returning to FIG. 1, the system 100 also includes the server 110. The server 110 includes a computing device, such as a server, a database, or the like. As illustrated in FIG. 4, the server 110 includes a server electronic processor 400, a server memory 405, and a server communication interface 410. The server electronic processor 400, the server memory 405, and the server communication interface 410 communicate wirelessly, over one or more communication lines or buses, or a combination thereof. The server 110 may include additional components than those illustrated in FIG. 4 in various configurations. For example, the server 110 may also include one or more human machine interfaces, such as a keyboard, keypad, mouse, joystick, touchscreen, display device, printer, speaker, and the like, that receive input from a user, provide output to a user, or a combination thereof. The server 110 may also perform additional functionality other than the functionality described herein. As one example, in some embodiments, the functionality described as being performed by one or more components of the radar system 105 (for example, the antenna controller 215, the radar electronic processor 205, the detection electronic processor 345, and the like) may be performed by the server 110. Also, the functionality described herein as being performed by the server 110 may be distributed among multiple servers or devices (for example, as part of a cloud service or cloud-computing environment). In some embodiments, the functionality (or a portion thereof) described herein as being performed by the server 100 may be performed by another device or component. As one example, the functionality performed by the server 110 may be performed by one or more components of the radar system 105, such as, for example, the radar electronic processor 205.

The server communication interface 410 may include a transceiver that communicates with the radar system 105, the user device 115, and the classification database 130 over the communication network 150 and, optionally, one or more other communication networks or connections. The server electronic processor 400 includes a microprocessor, an ASIC, or another suitable electronic device for processing data, and the server memory 405 includes a non-transitory, computer-readable storage medium. The server electronic processor 400 is configured to retrieve instructions and data from the server memory 405 and execute the instructions. As illustrated in FIG. 4, the server memory 405 includes an object classification application 450. The object classification application 450 is a software application executable by the server electronic processor 400. As described in more detail below, the server electronic processor 400 executes the object classification application 450 to classify an object (or an “unclassified” object) detected by the radar system 105 (for example, the object 200 of FIG. 2A or 2B). As one example, the server electronic processor 400 may execute the object classification application 450 to receive measurement data associated with an unclassified object detected by the radar system 105 and determine an object classification for the unclassified object.

The user device 115 includes a computing device, such as a desktop computer, a laptop computer, a tablet computer, a terminal, a smart telephone, a smart television, a smart wearable, or another suitable computing device that interfaces with a user. Although not illustrated in FIG. 1, the user device 115 may include similar components as the server 110, such as electronic processor (for example, a microprocessor, an ASIC, or another suitable electronic device), a memory (for example, a non-transitory, computer-readable storage medium), a communication interface, such as a transceiver, for communicating over the communication network 150 and, optionally, one or more additional communication networks or connections, and one or more human machine interfaces (for example, a display device). For example, to communicate with the server 110, the user device 115 may store a browser application or a dedicated software application executable by an electronic processor. The system 100 is described herein as providing an object classification service through the server 110. However, in other embodiments, the functionality described herein as being performed by the server 110 may be locally performed by the user device 115. For example, in some embodiments, the user device 105 may store the object classification application 450.

The user device 115 may be used by a user to track and monitor one or more objects detected by the radar system 105. In some embodiments, a user may use the user device 115 to initiate or control a countermeasure (for example, an intercept operation or the like) based on, for example, an object classification of a detected object. Accordingly, in some embodiments, the user device 115 is part of a tracking system or countermeasure system, which may include additional or different components than those illustrated.

The system 100 also includes the classification database 130. The classification database 130 includes classification data. In some embodiments, the classification data includes one or more sets of known characteristics associated with a known object classification. As one example, the classification data may include a set of known characteristics (such as, for example, a known shape, dimension, rotational characteristic, or the like) of a Zenit rocket booster. Alternatively, or in addition, the classification data may include a log of known measurements and a corresponding object classification for each set of known measurements included in the log of known measurements. As one example, the classification data may include a log of known rotational characteristic measurements for a Zenit rocket booster. Accordingly, the classification data may include physical attributes or features of an object, such as, for example, a shape of the airborne object (for example, a cone, a cylinder, and the like), a dimensional ratio of the airborne object, a dimension of the airborne object (for example, a length, a width, and the like), and the like. In some embodiments, the classification data is stored in another device, such as the server 110 or the user device 115. Accordingly, in such embodiments, the classification database 130 is combined with another device. As one example, the classification database 130 may be combined with the server 110 such that the classification data is stored in the server memory 405.

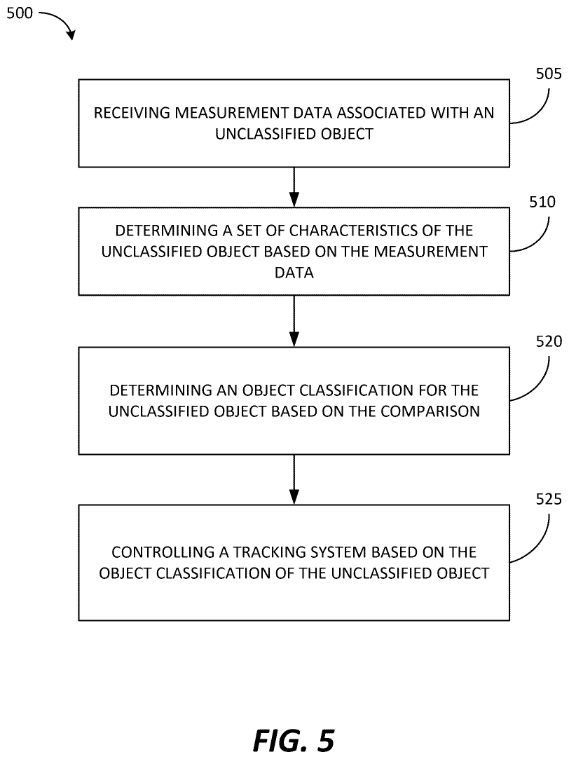

As noted above, the embodiments described herein provide methods and systems for, among other things, determining rotational frequencies, axes, moments, or a combination thereof of an unknown, tumbling object from observations by, for example, a remote continuous-wave radar (such as, for example, the radar system 105). FIG. 5 is a flowchart illustrating a method 500 for classifying an unclassified object performed by the system 100 according to some embodiments. The method 500 is described as being performed by the server 110 and, in particular, the object classification application 450 as executed by the server electronic processor 400. However, as noted above, the functionality described with respect to the method 500 may be performed by other devices, such as the radar system 105 or the user device 115, or distributed among a plurality of devices, such as a plurality of servers included in a cloud service.

As seen in FIG. 5, the method 500 includes receiving measurement data associated with an unclassified object (at block 505). The measurement data may include, for example, raw measurement data associated with the unclassified object detected by the radar system 105. With reference to FIG. 2A, the measurement data may be based on the radar return signals 235. In some embodiments, the measurement data includes data describing a variety of rotational, Doppler-shifted returns exhibited by a tumbling object (for example, the unclassified object 200 in FIG. 2B). The measurement data may represent certain physical feature dimensions or rotational characteristics associated with the unclassified object (for example, the object 200 in FIG. 2A or 2B) detected by the radar system 105. Accordingly, in some embodiments, the server electronic processor 400 receives the measurement data from the radar system 105 (for example, via the radar electronic processor 205). As one example, the measurement data may include positional information (such as a position of a reflector after a series of rotations), velocity information (such as a velocity of a reflector), or a combination thereof.

The server electronic processor 400 then determines a set of characteristics of the unclassified object based on the measurement data (at block 510). Accordingly, in some embodiments, in response to receiving the measurement data, the server electronic processor 400 determines the set of characteristics of the unclassified object. As one example, where the measurement data includes optional information, velocity information or a combination thereof with respect to the unclassified object, the server electronic processor 400 processes or analyzes the measurement data to determine individual rotational components describing the unclassified object, as described in greater detail below with respect to, for example, Equations 19a-19c, which represents individual velocity components of the unclassified object.

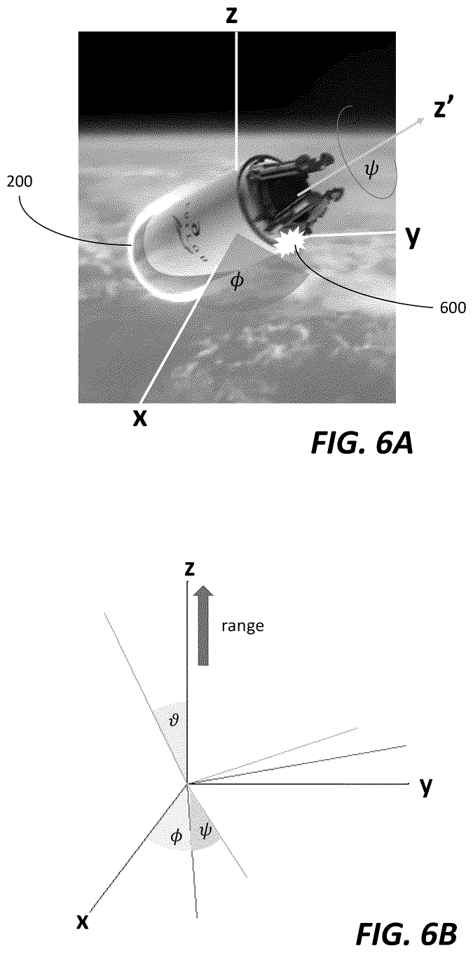

With reference to FIGS. 6A and 6B, consider a point at some position p₀ that is the position of a reflector located on a freely rotating object (for example, the unclassified object 200) in a state of spin, nutation, and precession. In some embodiments, the server electronic processor 400 creates body coordinates (x₀, y₀, z₀) with z₀ the principal axis, the remaining axes are arbitrary, but orthogonal and fixed to the object 200, and origin at the center of mass. The server electronic processor 400 may also create a second coordinate system (x,y,z) with z aligned to the total angular momentum vector of the rotating body (for example, the unclassified object 200).

With reference to FIG. 6A, the position and velocity of a reflector 600 may be represented at any time by initially aligning the spin axis with z and defining three time-dependent Euler angles. A first rotation then is about z₀ and represents spin with rotation matrix R_{ω}, a second rotation representing nutation is about the x axis with rotation matrix R_{η}, and a third rotation representing precession is about the z-axis with rotation matrix R_{Ω}. A position of the reflector 600 at any time may be determined from initial conditions and the rotation matrices provided below.

Position of the reflector 600 after this series of rotations is found from

$$p = {R}_{Ω} {R}_{η} {R}_{ω 0} {p}_{0} \qquad [ 1 ]$$

and the velocity of the reflector 600 is

$$\dot{p} = \frac{dp}{dt} = ( {\dot{R}}_{Ω} {R}_{η} {R}_{ω 0} + {R}_{Ω} {\dot{R}}_{η} {R}_{ω 0} + {R}_{Ω} {R}_{η} {\dot{R}}_{ω 0} ) {p}_{0} + {R}_{Ω} {R}_{η} {R}_{ω 0} {\dot{p}}_{0} \qquad [ 2 ]$$

The rotation matrices are

$${R}_{{ω}_{0}} = ( \begin{matrix}cos ( {ω}_{0} t ) & - sin ( {ω}_{0} t ) & 0 \\ sin ( {ω}_{0} t ) & cos ( {ω}_{0} t ) & 0 \\ 0 & 0 & 1\end{matrix} ) \qquad [ 3 ]$$

$${R}_{η} = ( \begin{matrix}1 & 0 & 0 \\ 0 & cos ( a + η t ) & - sin ( a + η t ) \\ 0 & sin ( a + η t ) & cos ( a + η t )\end{matrix} ) \qquad [ 4 ]$$

$${R}_{Ω} = ( \begin{matrix}cos ( Ω t ) & - sin ( Ω t ) & 0 \\ sin ( Ω t ) & cos ( Ω t ) & 0 \\ 0 & 0 & 1\end{matrix} ) \qquad [ 5 ]$$

with time derivatives

$${\dot{R}}_{ω 0} = {ω}_{0} ( \begin{matrix}- sin ( {ω}_{0} t ) & - cos ( {ω}_{0} t ) & 0 \\ cos ( {ω}_{0} t ) & - sin ( {ω}_{0} t ) & 0 \\ 0 & 0 & 1\end{matrix} ) \qquad [ 6 ]$$

$${\dot{R}}_{η} = η ( \begin{matrix}1 & 0 & 0 \\ 0 & - sin ( a + η t ) & - cos ( a + η t ) \\ 0 & cos ( a + η t ) & - sin ( a + η t )\end{matrix} ) \qquad [ 7 ]$$

$${\dot{R}}_{Ω} = Ω ( \begin{matrix}- sin ( Ω t ) & - cos ( Ω t ) & 0 \\ cos ( Ω t ) & - sin ( Ω t ) & 0 \\ 0 & 0 & 1\end{matrix} ) \qquad [ 8 ]$$

The full matrices are

$${R}_{Ω} {R}_{η} {R}_{ω0} = ( \begin{matrix}cos ( {ω}_{0} t ) cos ( Ω t ) - sin ( {ω}_{0} t ) cos ( a + η t ) sin ( Ω t ) & - sin ( {ω}_{0} t ) cos ( Ω t ) - cos ( {ω}_{0} t ) cos ( a + η t ) sin ( Ωt ) & sin ( a + η t ) sin ( Ω t ) \\ cos ( {ω}_{0} t ) sin ( Ω t ) + sin ( {ω}_{0} t ) cos ( a + η t ) cos ( Ω t ) & - sin ( {ω}_{0} t ) sin ( Ω t ) + cos ( {ω}_{0} t ) cos ( a + η t ) cos ( Ωt ) & - sin ( a + η t ) cos ( Ω t ) \\ sin ( {ω}_{0} t ) sin ( a + η t ) & cos ( {ω}_{0} t ) sin ( a + η t ) & - cos ( a + η t )\end{matrix} ) \qquad [ 9 ]$$

$${\dot{R}}_{Ω} {R}_{η} {R}_{ω0} = Ω ( \begin{matrix}- cos ( {ω}_{0} t ) sin ( Ω t ) - sin ( {ω}_{0} t ) cos ( a + η t ) cos ( Ω t ) & - sin ( {ω}_{0} t ) cos ( Ω t ) - cos ( {ω}_{0} t ) cos ( a + η t ) sin ( Ω t ) & sin ( a + η t ) cos ( Ω t ) \\ cos ( {ω}_{0} t ) cos ( Ω t ) - sin ( {ω}_{0} t ) cos ( a + η t ) sin ( Ω t ) & - sin ( {ω}_{0} t ) sin ( Ω t ) + cos ( {ω}_{0} t ) cos ( a + η t ) cos ( Ω t ) & sin ( a + η t ) sin ( Ω t ) \\ 0 & 0 & 0\end{matrix} ) \qquad [ 10 ]$$

$${R}_{Ω} {\dot{R}}_{η} {R}_{ω0} = η ( \begin{matrix}sin ( {ω}_{0} t ) sin ( a + η t ) sin ( Ω t ) & cos ( {ω}_{0} t ) sin ( a + η t ) sin ( Ω t ) & cos ( a + η t ) sin ( Ω t ) \\ - sin ( {ω}_{0} t ) sin ( a + η t ) cos ( Ω t ) & - cos ( {ω}_{0} t ) sin ( a + η t ) cos ( Ω t ) & - cos ( a + η t ) cos ( Ω t ) \\ sin ( {ω}_{0} t ) cos ( a + η t ) & cos ( {ω}_{0} t ) cos ( a + η t ) & sin ( a + η t )\end{matrix} ) \qquad [ 11 ]$$

$${R}_{Ω} {R}_{η} {\dot{R}}_{ω0} = {ω}_{0} ( \begin{matrix}- sin ( {ω}_{0} t ) cos ( Ω t ) - cos ( {ω}_{0} t ) cos ( a + η t ) sin ( Ω t ) & - cos ( {ω}_{0} t ) cos ( Ω t ) + sin ( {ω}_{0} t ) cos ( a + η t ) sin ( Ω t ) & 0 \\ - sin ( {ω}_{0} t ) sin ( Ω t ) + cos ( {ω}_{0} t ) cos ( a + η t ) cos ( Ω t ) & - cos ( {ω}_{0} t ) sin ( Ω t ) - sin ( {ω}_{0} t ) cos ( a + η t ) cos ( Ω t ) & 0 \\ cos ( {ω}_{0} t ) sin ( a + η t ) & - sin ( {ω}_{0} t ) sin ( a + η t ) & 0\end{matrix} ) \qquad [ 12 ]$$

The position vector following rotation is

$$p = ( \begin{matrix}{x}_{0} cos ( {ω}_{0} t ) cos ( Ω t ) - {x}_{0} sin ( {ω}_{0} t ) cos ( a + η t ) sin ( Ω t ) - {y}_{0} sin ( {ω}_{0} t ) cos ( Ω t ) - {y}_{0} cos ( {ω}_{0} t ) cos ( a + η t ) cos ( Ω t ) + {z}_{0} sin ( a + η t ) sin ( Ω t ) \\ {x}_{0} cos ( {ω}_{0} t ) sin ( Ω t ) + {x}_{0} sin ( {ω}_{0} t ) cos ( a + η t ) cos ( Ω t ) - {y}_{0} sin ( {ω}_{0} t ) sin ( Ω t ) + {y}_{0} cos ( {ω}_{0} t ) cos ( a + η t ) cos ( Ω t ) - {z}_{0} sin ( a + η t ) cos ( Ω t ) \\ {x}_{0} sin ( {ω}_{0} t ) sin ( a + η t ) + {y}_{0} cos ( {ω}_{0} t ) sin ( a + η t ) - {z}_{0} cos ( a + η t )\end{matrix} ) \qquad [ 13 ]$$

Accordingly, the components of velocity following rotation are:

$${v}_{x} = - {x}_{0} Ωcos ( {ω}_{0} t ) sin ( Ω t ) - {x}_{0} Ωsin ( {ω}_{0} t ) cos ( a + η t ) cos ( Ω t ) + {y}_{0} Ωsin ( {ω}_{0} t ) sin ( Ω t ) - {y}_{0} Ωcos ( {ω}_{0} t ) cos ( a + η t ) cos ( Ω t ) + {z}_{0} Ωsin ( a + η t ) cos ( Ω t ) + {x}_{0} ηsin ( {ω}_{0} t ) sin ( a + η t ) sin ( Ω t ) + {y}_{0} ηcos ( {ω}_{0} t ) sin ( a + η t ) sin ( Ω t ) + {z}_{0} ηcos ( a + η t ) sin ( Ω t ) - {x}_{0} {ω}_{0} sin ( {ω}_{0} t ) cos ( Ω t ) - {x}_{0} {ω}_{0} cos ( {ω}_{0} t ) cos ( a + η t ) sin ( Ω t ) - {y}_{0} {ω}_{0} cos ( {ω}_{0} t ) cos ( Ω t ) + {y}_{0} {ω}_{0} sin ( {ω}_{0} t ) cos ( a + η t ) sin ( Ω t ) + {v}_{0 x} cos ( {ω}_{0} t ) cos ( Ω t ) - {v}_{0 x} sin ( {ω}_{0} t ) cos ( a + η t ) sin ( Ω t ) - {v}_{0 y} sin ( {ω}_{0} t ) cos ( Ω t ) - {v}_{0 y} cos ( {ω}_{0} t ) cos ( a + η t ) sin ( Ω t ) + {v}_{0 z} sin ( a + η t ) sin ( Ω t ) \qquad [ 14 a ]$$

$${v}_{y} = {x}_{0} Ωcos ( {ω}_{0} t ) cos ( Ω t ) - {x}_{0} Ωsin ( {ω}_{0} t ) cos ( a + η t ) sin ( Ω t ) - {y}_{0} Ωsin ( {ω}_{0} t ) cos ( Ω t ) - {y}_{0} Ωcos ( {ω}_{0} t ) cos ( a + η t ) sin ( Ω t ) + {z}_{0} Ωsin ( a + η t ) sin ( Ω t ) - {x}_{0} ηsin ( {ω}_{0} t ) sin ( a + η t ) cos ( Ω t ) - {y}_{0} ηcos ( {ω}_{0} t ) sin ( a + η t ) cos ( Ω t ) - {z}_{0} ηcos ( a + η t ) cos ( Ω t ) - {x}_{0} {ω}_{0} sin ( {ω}_{0} t ) sin ( Ω t ) + {x}_{0} {ω}_{0} cos ( {ω}_{0} t ) cos ( a + η t ) cos ( Ω t ) - {y}_{0} {ω}_{0} cos ( {ω}_{0} t ) sin ( Ω t ) - {y}_{0} {ω}_{0} sin ( {ω}_{0} t ) cos ( a + η t ) cos ( Ω t ) + {v}_{0 x} cos ( {ω}_{0} t ) sin ( Ω t ) + {v}_{0 x} sin ( {ω}_{0} t ) cos ( a + η t ) cos ( Ω t ) - {v}_{0 y} sin ( {ω}_{0} t ) sin ( Ω t ) + {v}_{0 y} cos ( {ω}_{0} t ) cos ( a + η t ) cos ( Ω t ) - {v}_{0 z} sin ( a + η t ) cos ( Ω t ) \qquad [ 14 b ]$$

$${v}_{z} = {x}_{0} ηsin ( {ω}_{0} t ) cos ( a + η t ) + {y}_{0} ηcos ( {ω}_{0} t ) cos ( a + η t ) + {z}_{0} ηsin ( a + η t ) + {x}_{0} {ω}_{0} cos ( {ω}_{0} t ) sin ( a + η t ) - {y}_{0} {ω}_{0} sin ( {ω}_{0} t ) sin ( a + η t ) + {v}_{0 x} sin ( {ω}_{0} t ) sin ( a + η t ) + {v}_{0 y} cos ( {ω}_{0} t ) sin ( a + η t ) - {v}_{0 z} cos ( a + η t ) \qquad [ 14 c ]$$

The above are components of velocity in the respective directions. Consequently, the Doppler spectra of a given component is not visible to an observer unless its projection on the range vector r from the observer to the object (for example, the object 200) is not zero. For example, when the observer's range vector is along the x-axis, only the Doppler spectrum of vₓ is visible.

Let η=0 to assume no time-dependent nutation, so that the terms cos (a) and sin (a) are constants on the interval [0,1). These are written A and B=√(1−A²) respectively. Accordingly, the above equations become:

$$p = ( \begin{matrix}{x}_{0} cos ( {ω}_{0} t ) cos ( Ω t ) - {x}_{0} A sin ( {ω}_{0} t ) sin ( Ω t ) - {y}_{0} sin ( {ω}_{0} t ) cos ( Ω t ) - {y}_{0} A cos ( {ω}_{0} t ) sin ( Ω t ) + {z}_{0} B sin ( Ω t ) \\ {x}_{0} cos ( {ω}_{0} t ) sin ( Ω t ) - {x}_{0} A sin ( {ω}_{0} t ) cos ( Ω t ) - {y}_{0} sin ( {ω}_{0} t ) sin ( Ω t ) - {y}_{0} A cos ( {ω}_{0} t ) cos ( Ω t ) + {z}_{0} B cos ( Ω t ) \\ {x}_{0} B sin ( {ω}_{0} t ) + {y}_{0} B cos ( {ω}_{0} t ) - {z}_{0} A\end{matrix} ) \qquad [ 15 ]$$

$${v}_{x} = - ( {x}_{0} Ω + {x}_{0} {ω}_{0} A + {v}_{0 y} A ) cos ( {ω}_{0} t ) sin ( Ω t ) - ( {x}_{0} Ω A + {x}_{0} {ω}_{0} + {v}_{0 y} ) sin ( {ω}_{0} t ) cos ( Ω t ) + ( {y}_{0} Ω + {y}_{0} {ω}_{0} A - {v}_{0 x} A ) sin ( {ω}_{0} t ) sin ( Ω t ) - ( {y}_{0} Ω A + {y}_{0} {ω}_{0} - {v}_{0 x} ) cos ( {ω}_{0} t ) cos ( Ω t ) + {z}_{0} Ω B cos ( Ω t ) + {v}_{0 z} B sin ( Ω t ) \qquad [ 16 a ]$$

$${v}_{y} = ( {x}_{0} Ω + {x}_{0} {ω}_{0} A + {v}_{0 y} A ) cos ( {ω}_{0} t ) cos ( Ω t ) - ( {x}_{0} Ω A + {x}_{0} {ω}_{0} + {v}_{0 y} ) sin ( {ω}_{0} t ) sin ( Ω t ) - ( {y}_{0} Ω + {y}_{0} {ω}_{0} A - {v}_{0 x} A ) sin ( {ω}_{0} t ) cos ( Ω t ) - ( {y}_{0} Ω A + {y}_{0} {ω}_{0} - {v}_{0 x} ) cos ( {ω}_{0} t ) sin ( Ω t ) + {z}_{0} Ω B sin ( Ω t ) - {v}_{0 z} B cos ( Ω t ) \qquad [ 16 b ]$$

$${v}_{z} = ( - {y}_{0} {ω}_{0} + {v}_{0 x} ) B sin ( {ω}_{0} t ) + ( {x}_{0} {ω}_{0} + {v}_{0 y} ) B cos ( {ω}_{0} t ) - {v}_{0 z} A \qquad [ 16 c ]$$

Reorganizing vₓ and v_{y} results in

$${v}_{x} = \frac{1}{2} ( ( - {x}_{0} Ω - {x}_{0} {ω}_{0} - {v}_{0 y} ) ( 1 + A ) sin [ ( {ω}_{0} + Ω ) t ] + ( {x}_{0} Ω + {x}_{0} {ω}_{0} + {v}_{oy} ) ( 1 - A ) sin [ ( {ω}_{0} - Ω ) t ] ) + ( ( - {y}_{0} Ω - {y}_{0} {ω}_{0} + {v}_{0 x} ) ( 1 - A ) cos [ ( {ω}_{0} - Ω ) t ] + ( - {y}_{0} Ω - {y}_{0} {ω}_{0} + {v}_{0 x} ) ( 1 - A ) cos [ ( {ω}_{0} + Ω ) t ] ) + {z}_{0} Ω B cos ( Ω t ) + {v}_{0 z} B sin ( Ω t ) \qquad [ 17 a ]$$

$${v}_{y} = \frac{1}{2} [ ( {x}_{0} Ω + {x}_{0} {ω}_{0} + {v}_{y} ) ( 1 + A ) cos ( [ {ω}_{0} + Ω ] t ) + ( {x}_{0} Ω + {x}_{0} {ω}_{0} + {v}_{y} ) ( 1 + A ) cos ( [ {ω}_{0} - Ω ] t ) + ( - {y}_{0} Ω - {y}_{0} {ω}_{0} + {v}_{0 x} ) ( 1 + A ) sin ( [ {ω}_{0} + Ω ] t ) + ( - {y}_{0} Ω - {y}_{0} {ω}_{0} + {v}_{0 x} ) ( 1 + A ) sin ( [ {ω}_{0} - Ω ] t ) ] + {z}_{0} Ω B sin ( Ω t ) - {v}_{0 z} B cos ( Ω t ) \qquad [ 17 b ]$$

With respect to determining spectra using (2π)⁻¹ scaling, the Fourier transform pairs are:

$$cos [ ( {ω}_{0} + Ω ) t ] ⊃ π ( δ [ ω - ( {ω}_{0} + Ω ) ] + δ [ ω + ( {ω}_{0} + Ω ) ] ) \qquad [ 18 a ]$$

$$cos [ ( {ω}_{0} - Ω ) t ] ⊃ π ( δ [ ω - ( {ω}_{0} - Ω ) ] + δ [ ω + ( {ω}_{0} - Ω ) ] ) \qquad [ 18 b ]$$

$$sin [ ( {ω}_{0} + Ω ) t ] ⊃ - i π ( δ [ ω - ( {ω}_{0} + Ω ) ] - δ [ ω + ( {ω}_{0} + Ω ) ] ) \qquad [ 18 c ]$$

$$sin [ ( {ω}_{0} - Ω ) t ] ⊃ - i π ( δ [ ω - ( {ω}_{0} - Ω ) ] + δ [ ω + ( {ω}_{0} - Ω ) ] ) \qquad [ 18 d ]$$

Substituting for 1+A and 1−A results in:

$${v}_{x} ⊃ {V}_{x} ( ω ) = π ( [ - {y}_{0} Ω - {y}_{0} {ω}_{0} + {v}_{0 x} + i ( {x}_{0} Ω + {x}_{0} {ω}_{0} + {v}_{0 y} ) ] {cos}^{2} ( \frac{a}{2} ) ( δ [ ω - ( {ω}_{0} + Ω ) ] ) + [ - {y}_{0} Ω - {y}_{0} {ω}_{0} + {v}_{0 x} - i ( {x}_{0} Ω + {x}_{0} {ω}_{0} + {v}_{0 y} ) ] {cos}^{2} ( \frac{a}{2} ) δ [ ω + ( {ω}_{0} + Ω ) ] + [ - {y}_{0} Ω - {y}_{0} {ω}_{0} + {v}_{0 x} - i ( {x}_{0} Ω + {x}_{0} {ω}_{0} + {v}_{0 y} ) ] {sin}^{2} ( \frac{a}{2} ) δ [ ω - ( {ω}_{0} - Ω ) ] + [ - {y}_{0} Ω - {y}_{0} {ω}_{0} + {v}_{0 x} + i ( {x}_{0} Ω + {x}_{0} {ω}_{0} + {v}_{0 y} ) ] {sin}^{2} ( \frac{a}{2} ) δ [ ω + ( {ω}_{0} - Ω ) ] ) + π ( {z}_{0} ΩB - {iv}_{0 z} B ) δ [ ω - Ω ] + π ( {z}_{0} Ω B + {iv}_{0 z} B ) δ [ ω + Ω ] \qquad ( 19 a )$$

$$while$$

$${v}_{y} ⊃ {V}_{y} ( ω ) = {πcos}^{2} ( \frac{a}{2} ) [ [ ( {x}_{0} Ω + {x}_{0} {ω}_{0} + {v}_{y} ) + i ( {y}_{0} Ω + {y}_{0} {ω}_{0} - {v}_{0 x} ) ] δ [ ω - ( {ω}_{0} + Ω ) ] + [ ( {x}_{0} Ω + {x}_{0} {ω}_{0} + {v}_{y} ) + i ( {y}_{0} Ω + {y}_{0} {ω}_{0} - {v}_{0 x} ) ] δ [ ω + ( {ω}_{0} + Ω ) ] + [ ( {x}_{0} Ω + {x}_{0} {ω}_{0} + {v}_{y} ) + i ( {y}_{0} Ω + {y}_{0} {ω}_{0} - {v}_{0 x} ) ] δ [ ω - ( {ω}_{0} - Ω ) ] + [ ( {x}_{0} Ω + {x}_{0} {ω}_{0} + {v}_{y} ) + i ( {y}_{0} Ω + {y}_{0} {ω}_{0} - {v}_{0 x} ) ] δ [ ω + ( {ω}_{0} - Ω ) ] ] - π B ( {v}_{0 z} + {iz}_{0} Ω ) δ [ ω - Ω ] + π B ( {v}_{0 z} + {iz}_{0} Ω ) δ [ ω + Ω ] , \qquad [ 19 b ]$$

$$and$$

$${v}_{z} ⊃ {V}_{z} ( ω ) = π B ( ( x {ω}_{0} + {v}_{0 y} ) + ( {y}_{0} {ω}_{0} - {v}_{0 x} ) ) δ [ ω - {ω}_{0} ] + π B ( ( x {ω}_{0} + {v}_{0 y} ) + i ( {y}_{0} {ω}_{0} - {v}_{0 x} ) ) δ [ ω + {ω}_{0} ] \qquad [ 19 c ]$$

Regardless of the view direction, given no nutation, there will be between zero and six observable frequencies: ω₀, Ω, (ω₀+Ω), and ±(ω₀−Ω). This may be simplified by assuming that the reflector 600 is fixed on the body of the object 200 so that the components of v₀ are zero. As a result, the power spectra becomes:

$${P}_{x} = {π}^{2} {{r}_{xy 0}^{2} ( Ω + {ω}_{0} )}^{2} [ {cos}^{4} ( \frac{a}{2} ) ( δ [ ω - ( {ω}_{0} + Ω ) ] ) + {cos}^{4} ( \frac{a}{2} ) δ [ ω + ( {ω}_{0} + Ω ) ] + {sin}^{4} ( \frac{a}{2} ) δ [ ω - ( {ω}_{0} - Ω ) ] + {sin}^{4} ( \frac{a}{2} ) δ [ ω + ( {ω}_{0} - Ω ) ] ] + {{π}^{2} ( {z}_{0} Ω )}^{2} {B}^{2} δ [ ω - Ω ] + {{π}^{2} ( {z}_{0} Ω )}^{2} {B}^{2} δ [ ω + Ω ] \qquad [ 20 a ]$$

$${P}_{y} ⊃ {π}^{2} {{r}_{xy 0}^{2} ( Ω + {ω}_{0} )}^{2} {cos}^{4} ( \frac{a}{2} ) [ δ [ ω - ( {ω}_{0} + Ω ) ] + δ [ ω + ( {ω}_{0} + Ω ) ] + δ [ ω - ( {ω}_{0} - Ω ) ] + δ [ ω + ( {ω}_{0} - Ω ) ] ] + {{π}^{2} ( {z}_{0} Ω )}^{2} {B}^{2} δ [ ω - Ω ] + {{π}^{2} ( {z}_{0} Ω )}^{2} {B}^{2} δ [ ω + Ω ] \qquad [ 20 b ]$$

$${P}_{z} ⊃ {π}^{2} {r}_{xy 0}^{2} {ω}_{0}^{2} {B}^{2} [ δ [ ω - {ω}_{0} ] + δ [ ω + {ω}_{0} ] ] \qquad [ 20 c ]$$

As one example, when a reflector (for example, the reflector 600) is at the center of an endcap of a cylinder nearest the radar, x₀=y₀=0, and

$${P}_{x} = {{π}^{2} ( {z}_{0} Ω )}^{2} {B}^{2} ( δ [ ω - Ω ] + δ [ ω + Ω ] ) \qquad [ 21 a ]$$

$${P}_{y} ⊃ {{π}^{2} ( {z}_{0} Ω )}^{2} {B}^{2} ( δ [ ω - Ω ] + δ [ ω + Ω ] ) \qquad [ 21 b ]$$

$${P}_{z} ⊃ 0 \qquad [ 21 c ]$$

Alternatively, a reflector (for example, the reflector 600) at (x₀, y₀, 0) is

$${P}_{x} = {π}^{2} {{r}_{xy 0}^{2} ( Ω + {ω}_{0} )}^{2} [ {cos}^{4} ( \frac{a}{2} ) \{ δ [ ω - ( {ω}_{0} + Ω ) ] + δ [ ω + ( {ω}_{0} + Ω ) ] \} + {sin}^{4} ( \frac{a}{2} ) \{ δ [ ω - ( {ω}_{0} - Ω ) ] + δ [ ω + ( {ω}_{0} - Ω ) ] \} ] + {{π}^{2} ( {z}_{0} Ω )}^{2} {B}^{2} δ [ ω - Ω ] + {{π}^{2} ( {z}_{0} Ω )}^{2} {B}^{2} δ [ ω + Ω ] \qquad [ 22 a ]$$

$${P}_{y} ⊃ {π}^{2} {{r}_{xy 0}^{2} ( Ω + {ω}_{0} )}^{2} {cos}^{4} ( \frac{a}{2} ) [ δ [ ω - ( {ω}_{0} + Ω ) ] + δ [ ω + ( {ω}_{0} + Ω ) ] + δ [ ω - ( {ω}_{0} - Ω ) ] + δ [ ω + ( {ω}_{0} - Ω ) ] ] + {{π}^{2} ( {z}_{0} Ω )}^{2} {B}^{2} δ [ ω - Ω ] + {{π}^{2} ( {z}_{0} Ω )}^{2} {B}^{2} δ [ ω + Ω ] \qquad [ 22 b ]$$

$${P}_{z} ⊃ {π}^{2} {r}_{xy 0}^{2} {ω}_{0}^{2} {B}^{2} [ δ [ ω - {ω}_{0} ] + δ [ ω + {ω}_{0} ] ] \qquad [ 22 c ]$$

A specular reflector may be described as a surface and visible only when the surface normal is parallel and anti-directional to the range vector r from the observer to the object 200. The specular may be assumed to also have the characteristic of being “slippery” (i.e., independent of spin although not necessarily of precession).

Consider an example case of a side specular in a cylinder with z₀ the principle axis, and view axis in the direction r=−reₓ where eₓ=x/x, occurs when e_{x′}r=0. In Equation [13], for simplicity, set x₀=y₀=0 and find solutions for arbitrary z₀, which are t=nπ/Ω. This solution reflects the initial condition that the set-up (Equation [4]) puts the principle axis initially in the (y,z) plane. The components of the velocity may be calculated with these conditions from Equations [16], finding that v_{y} and v_{z} are zero while vₓ=z₀ ΩBcos(Ωt) with t as above, where z₀B is the radius of rotation. Therefore, there is an observable Doppler alternating in value between z₀ ΩB and −z₀ ΩB with the frequency of precession. With full side specular, the Doppler would reveal a continuum of speeds between 0 and a maximum z₀ₘₐₓ ΩB corresponding to the maximum distance of the reflector 600 from the center of rotation.

For an endcap specular the observer may be positioned at r (r, a, Ω₀), which aligns the body z₀ with r when Ω=Ω₀. Without little loss of generality for r large compared to the dimensions of the object 200, set Ω₀=π/2 and again let x₀=y₀=0. Then, the surface unit vector has components in the x and z directions, but (by substitution in Equations [14a] and [14c]) there is no contribution from Doppler to the reflection amplitude from precession, and, for pure specular reflection, the reflection amplitude is entirely due to the illumination and the reflectivity of the surface.

With respect to torque-free moments, a solid object with a single axis of symmetry in the absence of external torques maintains the relationship

$$Ω = \frac{{I}_{0} {ω}_{0}}{IA} \qquad [ 23 ]$$

where I is the moment of inertia about an axis normal to the principal axis, and I₀ is the principal moment of inertia. This is obtained from Euler's equations with the indicated conditions:

$$\begin{matrix}{I}_{0} {\dot{ω}}_{0} = ( I - I ) {ω}_{x} {ω}_{y} = 0 \\ I {ω}_{x} = ( {I}_{0} - I ) {ω}_{y} {ω}_{0} \\ I {ω}_{y} = - ( {I}_{0} - I ) {ω}_{0} {ω}_{x}\end{matrix} \qquad [ 24 ]$$

which may be rewritten

$$\begin{matrix}{ω}_{0} = {ω}_{z} = constant \\ {\dot{ω}}_{x} = {Ωω}_{y} \\ {\dot{ω}}_{y} = - {Ωω}_{x}\end{matrix} \qquad [ 25 ]$$

where Ω is given by Equation [23]. Differentiating Equations yield the equations of motion

$$\begin{matrix}{\ddot{ω}}_{x} = Ω {\dot{ω}}_{y} \to {\ddot{ω}}_{x} + {Ω}^{2} {ω}_{x} = 0 \\ {\dot{ω}}_{y} = {Ωω}_{y} \to {\ddot{ω}}_{y} + {Ω}^{2} {ω}_{y} = 0\end{matrix} . \qquad [ 26 ]$$

Substituting Equation into Equations results in:

$${P}_{x} = {π}^{2} {r}_{xy 0}^{2} {{ω}_{0}^{2} ( 1 + \frac{{I}_{0}}{IA} )}^{2} [ {cos}^{4} ( \frac{a}{2} ) \{ δ [ ω - {ω}_{0} ( 1 + \frac{{I}_{0}}{IA} ) ] + δ [ ω + {ω}_{0} ( 1 + \frac{{I}_{0}}{IA} ) ] \} + {sin}^{4} ( \frac{a}{2} ) \{ δ [ ω - {ω}_{0} ( 1 + \frac{{I}_{0}}{IA} ) ] δ [ ω + {ω}_{0} ( 1 + \frac{{I}_{0}}{IA} ) ] \} ] \qquad [ 27 a ]$$

$${P}_{y} ⊃ {π}^{2} {r}_{xy 0}^{2} {{ω}_{0}^{2} ( 1 + \frac{{I}_{0}}{IA} )}^{2} {cos}^{4} ( \frac{a}{2} ) [ δ [ ω - {ω}_{0} ( 1 + \frac{{I}_{0}}{IA} ) ] + δ [ ω + {ω}_{0} ( 1 + \frac{{I}_{0}}{IA} ) ] δ [ ω - {ω}_{0} ( 1 - \frac{{I}_{0}}{IA} ) ] + δ [ ω + {ω}_{0} ( 1 - \frac{{I}_{0}}{IA} ) ] ] \qquad [ 27 b ]$$

$${P}_{z} ⊃ {π}^{2} {r}_{xy 0}^{2} {ω}_{0}^{2} {B}^{2} [ δ [ ω - {ω}_{0} ] + δ [ ω + {ω}_{0} ] ] \qquad [ 27 c ]$$

As seen in FIG. 5, the server electronic processor 400 then determines an object classification for the unclassified object (at block 520). An object classification may indicate a specific type of airborne object (for example, a Zenit rocket booster). Alternatively, or in addition, an object classification may indicate a threat level associated with the object 200. A threat level may represent whether the unclassified object 200 is a threat, how much of a threat the unclassified object 200 is, and the like. As one example, the object classification may indicate that the unclassified object 200 is not a threat. As another example, the object classification may indicate that the unclassified object 200 poses a significant threat (such as a threat level warranting initiation of a countermeasure or interference operation).

The server electronic processor 400 determines the object classification for the unclassified object based on the set of characteristics determined at block 525 (for example, individual rotational or velocity components describing the unclassified object determined using Equations 19a-19c).

In some embodiments, the server electronic processor 400 determines the object classification by comparing the set of characteristics of the unclassified object to one or more sets of known characteristics. In such embodiments, the server electronic processor 400 accesses the classification data (for example, as the one or more sets of known characteristics) from the classification database 130. As noted above, the classification data may include, for example, physical attributes or features an object, such as, for example, a shape of the airborne object (for example, a cone, a cylinder, and the like), a dimensional ratio of the airborne object, a dimension of the airborne object (for example, a length, a width, and the like), rotational characteristic or behavior, and the like. Each set of known characteristics may be associated with a known object classification, such as, for example, a type of airborne object, a threat classification, or the like.

After accessing the one or more sets of known characteristics (for example, the classification data), the server electronic processor 400 compares the set of characteristics of the unclassified object to one or more sets of known characteristics to identify a match (for example, one or more sets of known characteristics that share one or more characteristics to the set of characteristics of the unclassified object. The server electronic processor 400 may identify a match between the set of characteristics of the unclassified object and at least one set of known characteristics when the set of characteristics of the unclassified object shares one or more characteristics with a set of known characteristics.

As one example, when the set of characteristics of the unclassified object indicates that the unclassified object is a cylinder about fourteen meters tall and four meters wide with certain rotational characteristics or behavior, the server electronic processor 400 may identify a set of known characteristics associated with a cylinder about fourteen meters tall and four meters wide with the same or similar rotational characteristics or behavior. Alternatively or in addition, the server electronic processor 400 may identify a match between the set of characteristics of the unclassified object and at least one set of known characteristics when the set of characteristics of the unclassified object falls within one or more characteristic ranges associated with a set of known characteristics. As one example, when the set of characteristics of the unclassified object indicates that the unclassified object is a cylinder about fourteen meters tall and four meters wide, the server electronic processor 400 may identify a set of known characteristics associated with a cylinder with a height range of ten to fifteen meters and a width range of one to five meters.

Alternatively, or in addition, in some embodiments, the server electronic processor 400 determines the object classification by accessing a log of known measurements and comparing one or more sets of measurements to the measurement data. The log of known measurements may include one or more sets of measurements and a corresponding object classification for each set of measurements. In some embodiments, the log of known measurements is stored in the classification database 130 (as part of the classification data). For example, as noted above, in some embodiments, the classification data may include a log of known measurements and a corresponding object classification for each set of known measurements included in the log of known measurements. As one example, the classification data may include a log of known rotational characteristic measurements for a Zenit rocket booster. After accessing the log of known measurements, the server electronic processor 400 compares the set of characteristics of the unclassified object to one or more sets of measurements (included in the log of known measurements) to identify a match (for example, one or more sets of measurements that share one or more measurements to the set of characteristics of the unclassified object.

Based on the object classification determined at block 520, the server electronic processor 400 may control a tracking system (at block 525). In some embodiments the server electronic processor 400 may control the tracking system by generating and transmitting one or more instructions, messages, or the like to a remote device (for example, over the communication network 150 of FIG. 1). As one example, the server electronic processor 400 may generate and transmit a message or information to the user device 115. The message may include, for example, the object classification, the set of characteristics determined in step 510, other information associated with the unclassified object 200 (for example, a time and date that the radar system 105 detected the unclassified object 200, an identification of the radar system 105 that detected the unclassified object 200, and the like), or a combination thereof. In response to receiving the message or information from the server electronic processor 400, the user device 115 may enable a user to view and interact with the message or information. As noted above, in some embodiments, the user device 115 may be part of the tracking system. In such embodiments, the user device 115 may enable a user to initiate or control a countermeasure operation, an interference operation, another action or operation, or a combination thereof with respect to the object 200.

Alternatively, or in addition, in some embodiments, the server electronic processor 400 controls the tracking system by generating a log entry for the object 200. The log entry may include, for example, the object classification, the set of characteristics determined in step 510, other information associated with the unclassified object 200 (for example, a time and date that the radar system 105 detected the unclassified object 200, an identification of the radar system 105 that detected the unclassified object 200, and the like), or a combination thereof. The server electronic processor 400 may store the log entry for the object 200 in a log or other database, which may be stored in the server memory 405, the classification database 130, a memory of the user device 115, or the like. In some embodiments, a user may access the log (including the log entries therein) using, for example, the user device 115 in order to review past object classifications. Accordingly, in some embodiments, the log may be a historical log of past object classifications.

Accordingly, the embodiments described herein provide, among other things, methods and systems for determining a tumbling state of a moving object. For example, one embodiment provides a method for classifying an airborne object detected by a radar system. The method includes identifying and classifying complex motion generated from received radar return signals. A tumbling object exhibits a variety of rotational, Doppler-shifted returns to a radar system that may be calculated from spectral, cepstral, and autocorrelation processing. These complex, rotational returns represent certain physical feature dimensions that may be extracted. The method further includes calculating the physical features of the airborne object. A physical feature of the airborne object may include, for example, a shape of the airborne object (for example, a cone, a cylinder, and the like), a dimensional ratio of the airborne object, a dimension of the airborne object (for example, a length, a width, and the like), and the like. The physical features may be compared to known or predetermined physical features stored in a classification database, where an object classification decision is made upon identifying a match between calculated physical features and known physical features of an object stored in the database.

Thus, the embodiments provide, among other things, methods and systems for classifying an object. Various features and advantages of certain embodiments are set forth in the following claims.

1.-5. (canceled)

6. A system for classifying an unclassified object, the system comprising:
an electronic processor configured to
receive, from a radar system, measurement data associated with the unclassified object,
determine a set of characteristics of the unclassified object based on the measurement data,
determine an object classification for the unclassified object based on the set of characteristics, and
control a tracking system based on the object classification of the unclassified object.

7. The system of claim 6, wherein the unclassified object exhibits spin, precision, and nutation.

8. The system of claim 6, wherein the measurement data is three-dimensional data representing spin, precession, and nutation of the unclassified object.

9. The system of claim 6, wherein the measurement data describes a set of rotational, Doppler-shifted radar returns exhibited by the unclassified object.

10. The system of claim 6, wherein the electronic processor is configured to analyze the measurement data to determine individual rotational components as the set of characteristics describing the unclassified object.

11. The system of claim 6, wherein the object classification indicates a type of airborne object.

12. The system of claim 6, wherein the object classification is a threat level associated with the unclassified object.

13. The system of claim 6, wherein the electronic processor is configured to determine the object classification by
comparing the set of characteristics of the unclassified object to one or more sets of known characteristics, and
identifying at least one set of known characteristics included in the one or more sets of known characteristics as a match with the set of characteristics of the unclassified object.

14. The system of claim 13, wherein the at least one set of known characteristics includes at least one characteristic with the set of characteristics of the unclassified object.

15. The system of claim 13, wherein at least one characteristic included in the set of characteristics of the unclassified object falls within a characteristic range associated with the at least one set of known characteristics.

16. The system of claim 13, wherein the at least one set of known characteristics includes at least one selected from a group consisting of a physical feature, a dimensional ratio, and a rotational characteristic.

17. The system of claim 6, wherein the electronic processor is configured to determine the object classification by
accessing a log of known measurements, the log of known measurements includes one or more sets of known measurements and corresponding object classifications for each set of known measurements,
comparing one or more sets of known measurements to the measurement data, and
identifying at least one set of known measurements from the log of known measurements, wherein the object classification is a corresponding object classification associated with the at least one set of known measurements.

18. The system of claim 6, wherein the electronic processor is configured to control the tracking system by initiating a countermeasure operation based on the object classification of the unclassified object.

19. The system of claim 6, wherein the electronic processor is configured to control the tracking system by generating a log entry for the unclassified object, wherein the log entry includes the object classification of the unclassified object.

20. A method for classifying an unclassified object, the method comprising:
receiving, from a radar system, measurement data associated with the unclassified object, wherein the unclassified object is exhibiting a tumbling motion;
determining, with an electronic processor, a set of characteristics of the unclassified object based on the measurement data;
determining, with the electronic processor, an object classification for the unclassified object based on the set of characteristics, and
controlling, with the electronic processor, a tracking system based on the object classification of the unclassified object.

21. The method of claim 20, wherein receiving the measurement data includes receiving three-dimensional data representing spin, precession, and nutation of the unclassified object.

22. The method of claim 20, wherein receiving the measurement data includes receiving a set of rotational, Doppler-shifted radar returns exhibited by the unclassified object.

23. The method of claim 20, wherein determining the object classification for the unclassified object includes determining at least one selected from a group consisting of a type of airborne object and a threat level associated with the unclassified object.

24. The method of claim 20, wherein determining the object classification includes
comparing the set of characteristics of the unclassified object to one or more sets of known characteristics, and
identifying at least one set of known characteristics included in the one or more sets of known characteristics as a match with the set of characteristics of the unclassified object.

25. The method of claim 20, wherein determining the object classification includes
accessing a log of known measurements, the log of known measurements includes one or more sets of known measurements and corresponding object classifications for each set of known measurements,
comparing one or more sets of known measurements to the measurement data, and
identifying at least one set of known measurements from the log of known measurements, wherein the object classification is a corresponding object classification associated with the at least one set of known measurements.
